(19) United States
(12) Patent Application Publication
(10) Pub. No.: US 2010/0044614 A1
(43) Pub. Date: Feb. 25, 2010

(54) EXHAUST GAS RECIRCULATION VALVE

(75) Inventors: Haruo Watanuki, Tokyo (JP); Satoru Hasegawa, Tokyo (JP); Naosuke Nojima, Tokyo (JP); Sotsuo Miyoshi, Tokyo (JP)

Correspondence Address: BIRCH STEWART KOLASCH & BIRCH, PO BOX 747, FALLS CHURCH, VA, 22040-0747, US

(73) Assignee: MITSUBISHI ELECTRIC CORPORATION, Tokyo (JP)

(21) Appl. No.: 12/515,955

(22) PCT Filed: Oct. 1, 2007
(86) PCT No.: PCT/JP2007/069200

§ 371 Date: May 22, 2009

(30) Foreign Application Priority Data
Dec. 28, 2006 (JP) 2006-355814

(51) Int. Cl. F16K 25/00

(52) U.S. Cl. 251/368

(57) ABSTRACT

A surface of a valve rod of an EGR valve is plated with chromium plating, and then the surface of the chrome plating is polished to the maximum height surface roughness of 1.0 μm to 3.2 μm.

### TECHNICAL FIELD

The present invention relates to an exhaust gas recirculation valve provided in a recirculation passage of exhaust gas of an engine.

### BACKGROUND ART

In an engine of a vehicle, an exhaust gas recirculation apparatus recirculating exhaust gas to an intake side is provided for the purpose of reducing NOx contained in the exhaust gas. An exhaust gas recirculation passage is provided with an EGR valve (“Exhaust Gas Recirculation” valve), and the EGR valve is controlled based on operating information etc. of the engine. Returning high-temperature exhaust gas as it is to the intake side invites the lowering of the efficiency of the engine. Thus, it is custom in general to provide an EGR cooler for cooling the high-temperature exhaust gas in the exhaust gas recirculation passage.

Among the exhaust gas exhausted to the environment from the EGR valve contains sulfur oxide coming from a fuel system and nitrate oxide and particulate matters (PM), such as soot etc., which are generated by combustion. Accordingly, not to impede to operation of the EGR valve by these harmful materials, it has been contrived applying agglutination preventing medium to a valve head (disk) and a valve seat (seat) (Patent Document 1).

Patent Document 1: JP-A2006-112419

Sulfur oxide and nitric acid compounds contained in an exhaust gas produce corrosive composed of sulfuric acid and nitric acid in an exhaust gas passage. This tendency becomes conspicuous by going down the temperature of EGR gas by an EGR cooler. Such corrosive also adheres to a valve rod. In this connection, exhaust system of diesel engine is provided with filter(PDF) for collecting particulate matters existing in exhaust gas. Also, there is an engine system that supplies unburnt fuel from the engine to the filter in effort to burn the particulate matters collected by the filter. When a portion of the unburnt fuel enters an exhaust gas recirculation passage, the particulate matters wear oil and cling in an oily state to the valve rod of an EGR valve. To be more exact, the mere application of the agglutination preventing medium to the valve head and the valve seat, as disclosed in Patent Document 1, is unsatisfactory to ensure an operation of the EGR valve exposed to the exhaust gas.

The present invention has been made in view of such a technical situation, and an object of the present invention is to provide a secure operation of the EGR valve exposed to the exhaust gas by putting the valve rod in a state hard to adhere soot etc., to the valve rod of the EGR valve.

### DISCLOSURE OF THE INVENTION

The present invention is an exhaust gas recirculation valve provided in an exhaust gas recirculation passage for recirculating exhaust gas of an engine, wherein a surface of a valve rod is plated, and further the plated surface is polished to the maximum height surface roughness of 1.0 μm to 3.2 μm.

With the EGR valve according to the present invention, since the maximum height surface roughness of the valve rod is improved, an adhesion force of extraneous matters adhered to the surface of the valve rod is accordingly lowered, leading to easy flake off of the extraneous matters. To say more precisely, sliding the valve rod along a bearing facilitates peels off of the extraneous matters therefrom, and avoids extraneous matters's hindering an operation of the valve rod.

### BRIEF DESCRIPTION OF THE DRAWINGS

FIG. 1 is a schematic view illustrating an engine equipped with an EGR valve to which the present invention is applied.

FIG. 2 is a sectional view illustrating an EGR valve according to the first embodiment of the present invention.

FIG. 3 is a diagram of a test in which a study is conducted to a relation between the degree of polishing of a surface of a valve rod and a separation stress of extraneous matters.

FIG. 4 is a graph showing the results of the test shown in FIG. 3.

### BEST MODE FOR CARRYING OUT THE INVENTION

Hereinafter, an embodiment of the present invention will now be described with reference to the accompanying drawings in order to explain the present invention in more detail.

### First Embodiment

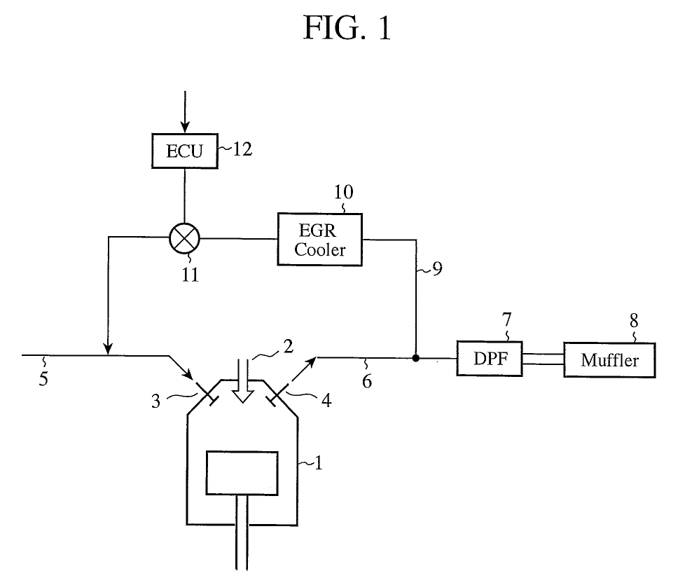

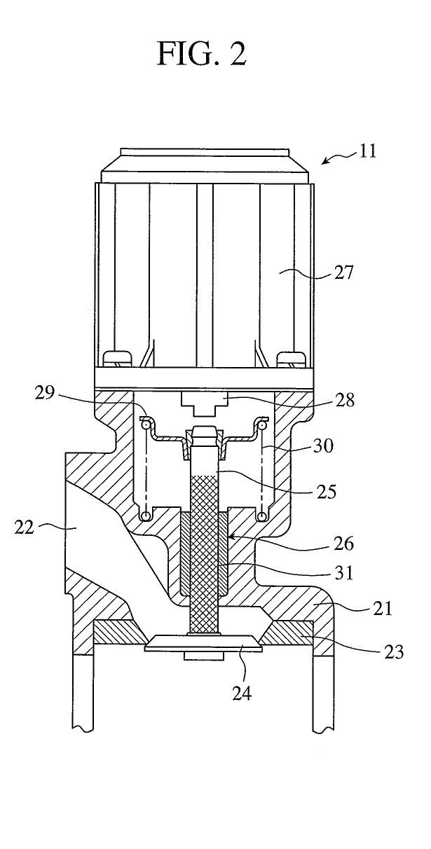

FIG. 1 is a schematic view illustrating an engine equipped with an EGR valve and an EGR cooler, and FIG. 2 is a sectional view illustrating the EGR valve according to the first embodiment of the present invention.

First, the outline of the engine which is the subject of the present invention will be discussed. A diesel engine 1 has a fuel injection nozzle 2 provided in a combustion chamber, and the combustion chamber is provided with an inlet valve 3 taking in air to the combustion chamber and an exhaust valve 4 exhausting combustion gas suffused in the combustion chamber. An intake passage 5 is connected to the inlet valve 3 and an exhaust passage 6 is connected to the exhaust valve 4. The exhaust passage 6 is sometimes provided with a DPF filter 7 for removing particulate matters (PM) contained in exhaust gas and further is provided with a muffler 8. The exhaust passage is provided with an exhaust gas recirculation passage 9 branched from the exhaust passage 6 and connected with the intake side, and the exhaust gas recirculation passage 9 is provided with an EGR cooler 10 and an EGR valve 11. The EGR cooler 10 takes a structure for cooling the exhaust gas by water cooling. The EGR valve 11 is controlled by an electronic control unit (ECU) 12. The EGR valve 11 controls the exhaust gas cooled by the EGR cooler 10 such that the optimum amount of the exhaust gas is supplied to the intake side based on a variety of information.

As shown in FIG. 2, in the EGR valve 11, a valve housing 21, which constitutes the main body of the EGR valve 11, is provided with an exhaust gas passage 22 for introducing the exhaust gas cooled by the EGR cooler 10 to the intake side. The exhaust gas passage 22 is provided with a valve seat (seat) 23 on the way of the passage, and the exhaust gas passage is further provided with a valve head (disk) 24 opening and closing the exhaust gas passage 22 by seating to and unseating from the valve seat 23. The valve head 24 is provided on a pointed end of a valve rod (handle) 25 by press fitting the valve rod etc. The valve rod 25 is axially supported in a slidable manner by a bearing 26 assembled in the valve housing 21. In passing, the bearing 26 consists of a mechanical bearing section, such as a bush etc., and a filter formed in the state like a sponge using a thin wire. The filter prevents foreign matters etc., from entering the bearing section.

The back end of the valve rod 25 is opposed to the pointed end of a rod 28 of an actuator 27 provided on the valve housing 21. The actuator 27 is driven and controlled by a command from the electronic control unit (see FIG. 1) The valve rod 25 has on its upper portion a spring holder 29 attached thereto, and between the spring holder 29 and the valve housing 21 is provided a spring 30 exerting a spring force on the valve rod 25, for causing the valve head 24 to seat to the valve seat 23. The actuator 27 is operated by the electronic control unit and the rod 28 axially presses the valve rod 25, which moves the valve head 24 relative to the valve seat 23 i.e. opens the valve. The rod 28 of the actuator 27 restores by a restoring force of the spring 30, thus seating the valve head 24 to the valve seat 23.

A surface of the valve rod 25 made of stainless steel etc., is plated with nickel or a nickel alloy, titanium or a titanium alloy, or chromium or a chromium alloy. To be more exact, electroless nickel plating, titanium-nickel plating, chromium plating, and hard chromium plating are employed. In the embodiment, the chromium plating 31 is applied. A portion where the chromium plating 31 is applied may be over the full length of the valve rod 25; however, the least the chromium plating 31 must be applied is a portion exposed to the exhaust gas and a portion sliding along the bearing 26.

The surface of the chromium plating 31 is polished with a polisher etc. The plating of the chromium plating 31 improves the maximum height surface roughness, and comes to a state hard to adhere for soot and corrosive contained in the exhaust gas.

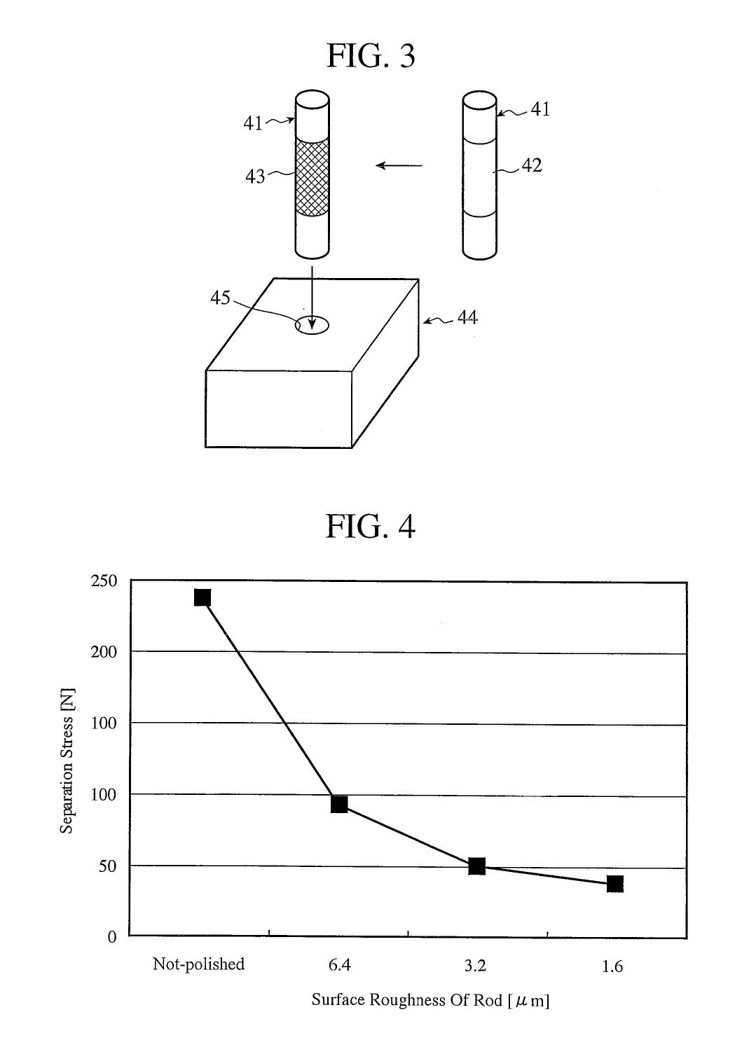

As illustrated in FIG. 3, a rod sample 41 being of a shape similar to that of the valve rod 25 is made, and the chromium plating 42 is applied on a surface thereof. As rod samples 41, the following samples are made: a sample not polishing the chromium plating 42; a sample polished to the maximum height surface roughness of 6.4 μm; a sample polished to the maximum height surface roughness of 3.2 μm; and a sample polished to the maximum height surface roughness of 1.6 μm. After that, those rod samples 41 are agglutinated by soot 43 etc., collected from the exhaust gas, then, as shown in FIG. 3, each of them is inserted in a hole 45 having a diameter equal to that of the rod sample 41, formed in a test block 44, and a force (removing force of soot etc.) needed for insertion of the sample at that time is measured. The results obtained therefrom are shown in FIG. 4.

As shown in FIG. 4, the rod sample 41 coated with the chromium plating 42 but not polished needs a force in the order of 240 N (newton) to insert the sample into the hole 45. The rod sample 41 polished to the maximum height surface roughness of 6.4 μm needs a force of about 95 N; the rod sample 41 polished to the maximum height surface roughness of 3.2 μm needs a force of about 50 N; and the rod sample 41 polished to the maximum height surface roughness of 1.6 μm needs a force of about 45 N. When the rod sample is polished to the maximum height surface roughness of 3.2 μm or less, the force for inserting the rod sample 41 into the hole 45 is gradually saturated. From this, the maximum height surface roughness in the order of 1.0 μm is deemed to be sufficient, considering the equipment and the cost to be incurred in the polishing process.

The test shows that an adhesion force of soot etc., adhered to the surface of the valve rod 25 becomes extremely weak, provided that the surface of the valve rod 25 is coated with the chromium plating 31 and then is polished to the maximum height surface roughness of 1.0 μm to 3.2 μm. Therefore, after the surface of the valve rod 25 is plated with chromium etc., one may polish the plated surface to the maximum height surface roughness of 1.0 μm to 3.2 μm.

With the EGR valve according to the embodiment, since the valve rod 25 has the extremely small maximum height surface roughness, the surface of the valve rod 25 is not liable to adhesion of soot etc., thus enabling the prevention of inoperativeness of the valve rod 25. Besides, even when soot etc., adheres to the surface of the valve rod 25, due to the extremely weak adhesion force of the shoot etc., the extraneous matters are easily removed off by sliding the valve rod 25 along the bearing 26.

### INDUSTRIAL APPLICABILITY

As mentioned above, the exhaust gas recirculation valve according to the present invention is capable of preventing soot etc., from adhering to the valve rod by improving the maximum height surface roughness of the valve rod, and thus the exhaust gas recirculation valve is suitable, e.g., for a gas recirculation valve provided in a recirculation passage of the exhaust gas of an engine.

1. An exhaust gas recirculation valve provided in an exhaust gas recirculation passage for recirculating exhaust gas of an engine, wherein a surface of a valve rod of the valve is plated and further the plated surface is polished to the maximum height surface roughness of 1.0 μm to 3.2 μm.

2. The exhaust gas recirculation valve as claimed in claim 1, wherein the plating is chromium plating.
